(19) United States
(12) Patent Application Publication
(10) Pub. No.: US 2006/0042553 A1
(43) Pub. Date: Mar. 2, 2006

(54) Pet litter

(76) Inventor: William R. Venezio, Schenectady, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 11/221,082

(22) Filed: Sep. 7, 2005

Related U.S. Application Data
(63) Continuation-in-part of application No. 10/928,988, filed on Aug. 30, 2004.

(51) Int. Cl. A01K 29/00

(52) U.S. Cl. 119/173

(57) ABSTRACT

A pet litter composed of limestone particles in the size range of 0.0001 mm to 4.75 mm which clump readily when contacted by pet urine, particularly cat urine. The particle size is typically between 0.6 mm and 1.18 mm. In addition, a thickener that may be digested by cats may be added to the limestone base to enhance the clumping properties of the litter. The composition can range from 80% limestone particles:20% thickener to 98% limestone particle:2% thickener. A typical composition is 98% limestone particles and 2% thickener.

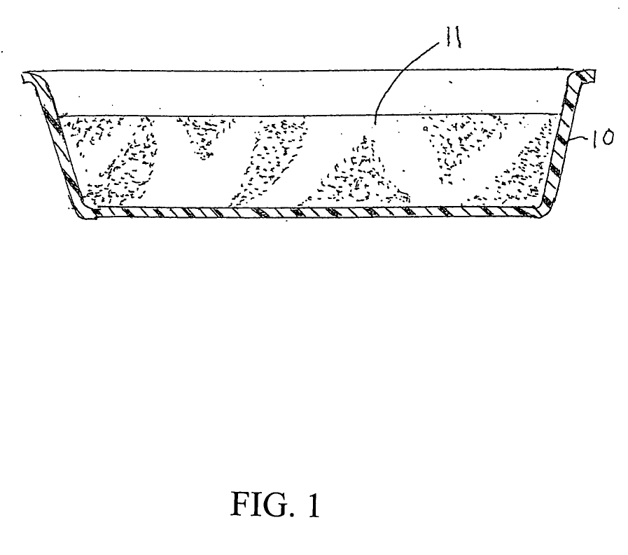

### CROSS REFERENCE TO RELATED APPLICATIONS

The present patent application is a continuation-in-part of a copending non-provisional U.S. patent application Ser. No. 10/928,988, filed Aug. 30, 2004 by the present inventor and entitled “Pet Litter.”

### FIELD OF THE INVENTION

The present invention relates generally to a pet litter, particularly for cats. The present invention includes limestone particles and a thickener other than a bentonite clay.

### RELATED ART

Most clumping pet litters on the market today use a bentonite clay, which naturally absorbs liquid, to promote clumping.

In addition, several patents have described the use of limestone particles in combination with various other materials in cat litter.

For example, U.S. Pat. No. 4,671,208 to Smith discloses a cat litter composition which combines ground clay, for its ability to absorb cat urine, with less expensive crushed dolomitic limestone, which acts to reduce odors by neutralizing acid in the cat urine. Smith states that while the limestone in its crushed state adsorbs liquids on the surface, the clay particles have a much greater tendency to absorb liquid. When the limestone is mixed with clay, any moisture adsorbed on the surface of the limestone particles is quickly absorbed by the clay, making it unnecessary to remove all the water from the crushed limestone before adding it to the ground clay. The clay particle size could be from 4/45 mesh (4.74 mm/0.355 mm), and preferably is 8/45 mesh (2.36 mm/0.355 mm). The dolomitic limestone particle size could be 8/45 mesh, and preferably is 16/25 mesh (1.18 mm/0.710 mm).

Johnson U.S. Pat. No. 4,465,019 discloses a pet litter having pieces of dried citrus pulp of a size to coat and adhere to the animal's feces, as well as to deodorize both feces and urine, and smaller “fines” which absorb the urine. In processing the citrus fruit, for the purpose of removing the soft, moist, slippery coating of squeezed citrus fruit, dolomitic limestone is added to the squeezed citrus fruit before it is cut into small pieces.

Stapley U.S. Pat. No. 4,355,593 cites limestone as one of many absorptive litter materials to which he adds a small amount of ground sagebrush particles and/or sagebrush oil for odor control purposes. In one embodiment, sagebrush particles 1.40 mm or smaller (passing through a Tyler No. 14 screen) and absorptive litter material particles of approximately the same size are pelletized by being extruded through a 1/16 to ½ inch diameter die and then cut into short lengths, typically 1/16 to ½ inch or more. In another embodiment, ground sagebrush and the absorptive litter material are combined after being separately formed into pellets. In yet another embodiment, sage brush oil is either absorbed or deposited on pellets of the absorptive litter material or on particles of that material which are pelletized later.

Various other pet litter formulations a disclosed in Nelson U.S. Pat. No. 5,062,383, Goss et al U.S. Pat. No. 5,359,961, Lander U.S. Pat. No. 4,471,717, Moore U.S. Pat. No. 5,961,968, Elazier-Davis et al U.S. Pat. No. 5,577,463, Lojek et al U.S. Pat. No. 4,676,196, and Greenberg U.S. Pat. No. 4,638,763.

### SUMMARY OF THE INVENTION

The present invention is directed to the use as a pet litter of limestone particles of a size to assure clumping when contacted by pet urine.

Preferably, the present invention uses as a pet litter limestone particles, which may be dolomitic, calcitic, or any other type of limestone, in the size range from 0.1 μm to 4.75 mm. Limestone is primarily calcium carbonate, CaCo₃; dolomite is primarily calcium magnesium carbonate, CaMg(CO₃)₂. Where limestone and dolomite occur together naturally the material is commonly known as dolomitic limestone.

A principal object of this invention is to provide a novel and advantageous particulate pet litter which clumps readily when exposed to pet urine.

Further objects and advantages of this invention will be apparent from the following detailed description of a presently preferred embodiment thereof, with reference to the accompanying drawing.

A first general aspect of the invention provides an animal litter composition consisting essentially of limestone particles and thickener, wherein said thickener produces viscosity when contacted with urine such that a clump is formed out of the litter and urine, and wherein said thickener may be digested by cats.

A second general aspect of the invention provides a pet litter consisting essentially of limestone particles and guar gum, wherein said limestone particles are sized between 0.0001 mm and 4.75 mm.

A third general aspect of the invention provides a method of preparing a pet litter box which comprises the steps of: reducing limestone to particles 0.0001 mm to 4.75 mm in size; combining said limestone particles with a thickener to form a pet litter; and placing said pet litter in a receptacle as a litter bed therein.

### BRIEF DESCRIPTION OF THE DRAWING

The single FIGURE of the drawing is a vertical section through a pet litter box in accordance with the present invention, consisting of a conventional open-topped pet litter receptacle and a bed of limestone particles in accordance with the present invention.

### DETAILED DESCRIPTION OF THE INVENTION

Before explaining the present invention in detail, it is to be understood that the invention is not limited in its application to the particular arrangement shown and described since the invention is capable of other embodiments. Also, the terminology used herein is for the purpose of description and not of limitation.

In accordance with the preferred embodiment of this invention, limestone, which may be dolomitic, calcitic, or any other type of limestone, is crushed, washed, dried, and screened to pass only particles within the size range from 0.0001 mm (0.1 μm) to 4.75 mm. Preferably without additives, the limestone particle mix 11 is put in a conventional, urine-proof, open-topped receptacle 10. Together they make up what is commonly called a “litter box.”

The use of limestone particles in this size range as a pet litter, particularly a cat litter, is based on observation of a noticeable clumping effect when an acidic watery solution, such as cat urine, contacts a bed of such particles. The overall reaction when an acidic solution, such as pet urine, is dripped onto ground limestone is as follows:
CaCO₃+H₂O^{acid} ? CO_{2(g)}+Ca(OH)₂
It appears that the reaction product calcium hydroxide is primarily responsible for the clumping of the limestone particles that was observed. The carbon dioxide evolved from the reaction makes the reaction irreversible.

Under microscopic examination before the reaction, the limestone particles have a white powdery coating, presumably calcium carbonate, on the particle surfaces. Tests indicate that the above-specified chemical reaction takes place primarily in this coating because there is no significant change in the particle size as a result of the reaction. Bubbling of hydrogen dioxide gas is observed, taking place more vigorously on the smaller sized particles than on the larger ones within the size range previously specified herein. Clumping is more pronounced the smaller the limestone particle size, so for purposes of this invention, the smaller the better.

In addition to its advantageous clumping properties, the ground limestone of the present invention acts as an odor-fighting material, as recognized in the prior art.

Preferably, the cat litter material of the present invention consists essentially of ground limestone, as specified, with nothing else added. However, without departing from the teaching of this invention, one or more other materials may be included in the litter bed 11 to add color or absorb or mask the odor caused by pet urine, so long as these additional materials do not significantly diminish the clumping properties of the limestone particles.

An embodiment of the present invention uses as a pet litter a base of limestone particles with a thickener added. The limestone particles range in size 0.1 μm (0.0001 mm) to 4.75 mm. The limestone particles may be dolomitic or calcitic limestone, or any other type of limestone. The thickener produces viscosity when contacted with urine and enhances the clumping properties of the litter. Thus, when limestone particles that are too large to clump on their own are included in the pet litter, the thickener ensures that the litter will clump when it becomes wet. The animal litter composition of this embodiment contains primarily limestone, comprising 80-98% of the litter. A small amount of thickener, between 2 and 20%, is added to the limestone base. Thus, the composition of the present invention could range from 98% limestone particles:2% thickener to 80% limestone particles:20% thickener.

The thickener used must be digestible by cats to avoid the problems that may be associated with clumping cat litters that include clumping components that are not digestible, such as bentonite clays, particularly sodium bentonite. For example, aside from breathing in the dust when in the litter box, after cats that have been in a clumping litter clean themselves with their mouths, they ingest a portion of the cat litter. The litter in the cat expands and can form a mass or coating on the respiratory and/or intestinal track of the cat. Dehydration, prevention of absorption of nutrients, respiratory problems, and depressed immune systems may result. However, if the clumping agent is digestible by the animal, the animal's body is better able to process any ingested dust or particles.

Thickeners such as any form of guar gum, such as powder or granular guar gum, cellulose gum, xanthan gum, carob gum, locust bean gum, starch, carrageenan, alginate, and any combination of these compounds may be added to the limestone particle base. The pet litter, including the thickener, does not contain bentonite clays, including sodium bentonite. Instead, the thickener can be, but does not need to be, food grade, as most of the thickeners listed are used as food additives. The thickener should not need to be heated to get thick and should disperse and swell in either hot or cold water. Any viscosity grade, or type, of thickener can be used. The thickener initially forms the pet litter and urine into a clump, then, once it is ingested, begins to dissolve. Therefore, the litter is able to pass through the cat's digestive system.

The pet litter is formed by reducing the limestone to particles 0.0001 mm to 4.75 mm in size and combining the thickener with the limestone particles. The ingredients are mechanically blended to form the pet litter. Any form of mechanical mixing may be used. The reducing of particle size and combining of the particles can be executed in any order. For example, the limestone may be crushed and placed through a mesh sieve to achieve the desired particle size, then the limestone particles and the thickener may be placed in a ribbon blender which stirs up the dry products. The blended animal, or pet, litter is placed in a receptacle, or litter box, and forms the litter bed therein.

One embodiment of the animal litter uses 98% limestone particles and 2% guar gum. The limestone particles are reduced to approximately a 16/30 mesh particle size (the particles pass through a U.S. mesh 16 screen but not through a U.S. mesh 30 screen). Thus, the particles are approximately between 0.6 mm and 1.18 mm in size. Guar gum, a natural, nontoxic and biodegradable product, is added in powder form. The ingredients are combined and used as a pet litter. When the litter is contacted with pet urine, the guar gum reacts by gelling within seconds of becoming wet. If an animal, such as a cat, ingests the litter, the guar gum is digested by the cat and the litter passes through the cat's digestive system.

The foregoing description of the present invention has been presented for purposes of illustration and description. It is not intended to be exhaustive or to limit the invention to the precise form disclosed, and many modifications and variations are possible in light of the above teaching. Such modifications and variations that may be apparent to a person skilled in the art are intended to be included within the scope of this invention as defined by the accompanying claims.

I claim:

1. An animal litter composition consisting essentially of limestone particles and thickener, wherein said thickener produces viscosity when contacted with urine such that a clump is formed out of the litter and urine, and wherein said thickener may be digested by cats.

2. The animal litter of claim 1, wherein said thickener is selected from the group consisting of any form of guar gum, cellulose gum, xanthan gum, carob gum, locust bean gum, starch, carrageenan, alginate, and any combination of said compounds.

3. The animal litter of claim 1, wherein said thickener is a food grade thickener.

4. The animal litter of claim 1, wherein the animal litter does not contain bentonite clays.

5. The animal litter of claim 1, wherein the thickener comprises between 2% and 20% of the animal litter composition.

6. The animal litter of claim 1, wherein the thickener comprises 2% of the animal litter composition.

7. A pet litter consisting essentially of limestone particles and guar gum, wherein said limestone particles are sized between 0.0001 mm and 4.75 mm.

8. The pet litter of claim 7, wherein the pet litter does not contain bentonite clays.

9. The pet litter of claim 7, wherein the guar gum is in granular form.

10. The pet litter of claim 7, wherein the guar gum is in powder form.

11. A method of preparing a pet litter box which comprises the steps of: reducing limestone to particles 0.0001 mm to 4.75 mm in size; combining said limestone particles with a thickener to form a pet litter; and placing said pet litter in a receptacle as a litter bed therein.

12. The method of preparing a pet litter box as in claim 11, wherein said thickener is selected from the group consisting of cellulose gum, xanthan gum, carob gum, locust bean gum, starch, carrageenan, alginate, and any combination of said compounds.

13. The method of preparing a pet litter box as in claim 11, wherein said thickener is guar gum.

14. The method of preparing a pet litter box as in claim 11, further comprising reducing said limestone to particles approximately between 0.6 mm and 1.18 mm in size.
